(19) United States
(12) Patent Application Publication
(10) Pub. No.: US 2010/0293268 A1
(43) Pub. Date: Nov. 18, 2010

(54) EFFICIENT MESSAGE CONSUMPTION IN A POINT-TO-POINT MESSAGING ENVIRONMENT

(75) Inventors: Gareth Edward Jones, Hursley Park (GB); Matthew Robert Whitehead, Hursley Park (GB)

Correspondence Address: Scully, Scott, Murphy & Presser, P.C., 400 Garden City Plaza, Suite 300, Garden City, NY, 11530, US

(73) Assignee: INTERNATIONAL BUSINESS MACHINES CORPORATION, Armonk, NY (US)

(21) Appl. No.: 12/465,242

(22) Filed: May 13, 2009

(51) Int. Cl. G06F 15/173

(52) U.S. Cl. 709/224

(57) ABSTRACT

A method and system for assigning a message to an application instance are disclosed. Message processing times of a currently available application instance and a currently unavailable application instance are measured. An unavailable time of the currently unavailable application instance is approximated based on the estimated message processing time of the currently unavailable application instance. The unavailable time and estimated message processing time of the currently unavailable application instance are added to generate an updated processing time of the currently unavailable application instance. The estimated processing time of the currently available application instance and the updated processing time of the currently unavailable application instance are compared. If the updated processing time of the currently unavailable application instance is less than the estimated processing time of the currently available application instance, the currently unavailable application instance is selected to process the message. Otherwise, the currently available application instance is selected.

### FIELD OF THE INVENTION

1. Technical Field

The present invention relates to distributing traffic across a collective group of machines based on current and previous knowledge gathered about the applications receiving and processing traffic on the machines.

2. Description of Related Art

Load Balancers distribute load to a collection of machines to provide extended scalability and availability to applications. As a service becomes more popular, its ability to serve a larger number of requests becomes critical. One solution to this problem is to create copies of the service to which some of the requests can be sent. The load balancer's job is to distribute the load across all available copies. The method in which the load balancer chooses to distribute the load can make a big difference on the overall effect seen by users of the service and the efficiency of the servers being used. Current methods used by load balancers to distribute the load include purely algorithmic methods, system-metric based methods, and “application-alive” checks.

The purely algorithmic methods include no information about the actual service or the likelihood that the service could complete the task in a particular time period (or complete the task at all). Example of some of these methods are round robin, weighted round robin, least connections, and hash methods.

System-metric based methods use statistics about the system on which the server is running in its decision making process. This information is useful, but may not be descriptive enough as the service itself may not be contributing to the system statistics in an intuitive manner.

Application-alive checks determine if the application is functioning as part of the load balancing operation. For example, load balancers will not send traffic to an application that has either died or has malfunctioned.

Application instance metrics determine which of a number of available application instances is best able to service a particular request or message. The metrics are fed into the load balancer in order to dynamically adjust workload balancing weights. For example, load balancers will not send traffic to a high latency application where a low latency application is available and where minimising system latency is important to the request being processed.

Thus, some of traditional load balancing mechanisms use methods that have no ability to make informed judgments about application instances which are currently unavailable (e.g. still processing previous requests), but which may be in a better position to serve requests than instances which are available. Other traditional load balancing mechanisms do not provide clear indications about how well a currently unavailable application instance might be able to service particular requests. Using application instance specific metrics addresses some of these problems, but does not allow for currently unavailable application instances to process the requests, at the time of determining an application instance to process the requests. For example, it may be desirable at the time of receiving a message or request to keep hold of it until a more desirable application instance becomes available, if that application instance were known to be able to process the request more quickly.

### SUMMARY OF THE INVENTION

To overcome the shortcomings noted above, preferably, application instances which are currently unavailable are considered by the load-balancers. Prior to distributing a request to a currently available application instance, weights of currently unavailable application instances are used to identify any instances that may be better able to process the request, rather than simply dispatching the request to any of the application instances that are available at the time when selecting an application instance to process the request. The request is then distributed to either an available application instance, or held until a currently unavailable application instance becomes available, depending on which instance is better able to process the request. For example, an application instance which is currently processing other requests, but which has a far lower latency than all of currently available applications, may be chosen to handle the request.

It is therefore an object of the present invention to provide a method, system, computer program product, and computer readable medium for assigning a message to an application instance (e.g., Java® Message Service (JMS) consumer) to process the message, e.g., by considering performance of each application instance, which is currently available or unavailable (i.e., currently busy to process a previous message).

In an embodiment there is provided a method, in a data processing system including a plurality of application instances on one or more computing devices, the plurality of application instances including a currently available application instance and a currently unavailable application instance, for assigning a message to an application instance among the plurality application instances including the currently available application instance and the currently unavailable application instance, the method comprising:

estimating message processing times of a currently available application instance and the currently unavailable application instance;

approximating an unavailable time of the currently unavailable application instance based on the estimated message processing time of the currently unavailable application instance;

using the unavailable time of the currently unavailable application instance and the estimated message processing time of the currently unavailable application instance to generate an updated processing time of the currently unavailable application instance;

comparing the estimated processing time of the currently available application instance and the updated processing time of the currently unavailable application instance; and

selecting the currently unavailable application instance to process the message if the updated processing time of the currently unavailable application instance is less than the estimated processing time of the currently available application instance.

In another embodiment there is provided a computer readable medium storing computer program instructions being executed by a processor for causing a data processing system including a plurality of application instances to perform method steps for assigning a message to an application instance among the plurality application instances including a currently available application instance and a currently unavailable application instance, said method steps comprising:

estimating message processing times of a currently available application instance and the currently unavailable application instance;

approximating an unavailable time of the currently unavailable application instance based on the estimated message processing time of the currently unavailable application instance;

using the unavailable time of the currently unavailable application instance and the estimated message processing time of the currently unavailable application instance to generate an updated processing time of the currently unavailable application instance;

comparing the estimated processing time of the currently available application instance and the updated processing time of the currently unavailable application instance; and

selecting the currently unavailable application instance to process the message if the updated processing time of the currently unavailable application instance is less than the estimated processing time of the currently available application instance.

In still another embodiment there is provided a data processing system including a plurality of application instances on one or more computing devices, the plurality of application instances including a currently available application instance and a currently unavailable application instance, for assigning a message to an application instance among the plurality application instances including the currently available application instance and the currently unavailable application instance, comprising:

means for estimating message processing times of a currently available application instance and the currently unavailable application instance;

approximating an unavailable time of the currently unavailable application instance based on the estimated message processing time of the currently unavailable application instance;

means for using the unavailable time of the currently unavailable application instance and the estimated message processing time of the currently unavailable application instance to generate an updated processing time of the currently unavailable application instance;

means for comparing the estimated processing time of the currently available application instance and the updated processing time of the currently unavailable application instance; and

means for selecting the currently unavailable application instance to process the message if the updated processing time of the currently unavailable application instance is less than the estimated processing time of the currently available application instance.

In a further embodiment, the data processing system further comprises: means for selecting the currently available application instance, otherwise.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the conception and specific embodiment as a base for designing or modifying the structures for carrying out the same purposes of the present invention and that such other features do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is an exemplary diagram of a distributed data processing environment;

FIG. 2 is an exemplary diagram of a server computing device;

FIG. 3 is an exemplary diagram of a client computing device;

FIG. 4 is a flowchart describing method steps executed according to one embodiment of the present invention.

### DETAILED DESCRIPTION OF THE PREFERRED EMBODIMENT

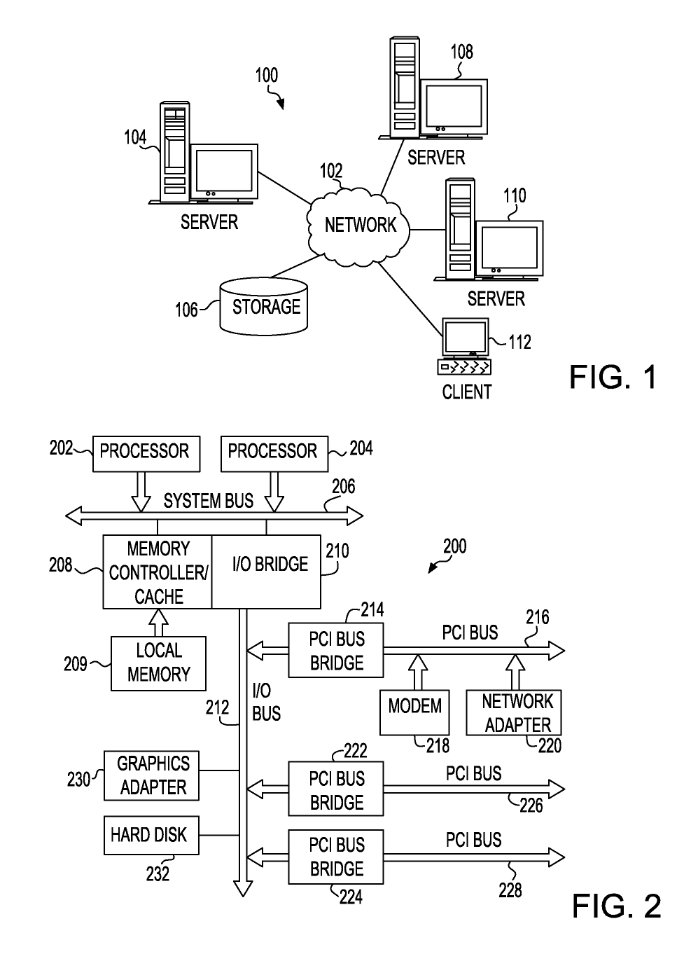

The present invention is directed to a mechanism for performing load balancing of requests to application instances on one of more than one server computing device. These requests may be generated by other servers, client computing devices, or other computing devices that may act as sources of requests for application resources on a server computing device. As such, the present invention is especially suited for use in a distributed data processing environment. FIGS. 1-3 provide a general overview of an exemplary distributed data processing system, and the computing devices therein, in order to give a context for an exemplary environment in which the present invention may be implemented.

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

Servers 104, 108 and 110 are connected to network 102 along with storage unit 106 and client 112 is connected to network 102. Client 112 can be, for example, a personal computer or network computer, and servers 104, 108 and 110 provide data, such as boot files, operating system images, and applications to client 112. Network data processing system 100 may include additional servers, clients, and other devices not shown.

In FIG. 2, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Network data processing system 100 also may be implemented as a number of different types of networks, such as for example, an intranet, a local area network (LAN), or a wide area network (WAN).

FIG. 2 shows a block diagram of a data processing system that may be implemented as a server, such as server 104, 108 or 110 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208 which provides an interface to local memory 209. I/O bus bridge 210 is connected to system bus 206 and provides an interface to I/O bus 212. Memory controller/cache 208 and I/O bus bridge 210 may be integrated as shown.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as shown, either directly or indirectly. Other peripheral devices, such as optical disk drives and the like, may be used in addition to or in place of the hardware shown.

The data processing system in FIG. 2 may be, for example, an IBM® eServer™ pSeries system, a product of International Business Machines® Corporation in Armonk, N.Y., running an Advanced Interactive Executive (AIX)® operating system or LINUX® operating system.

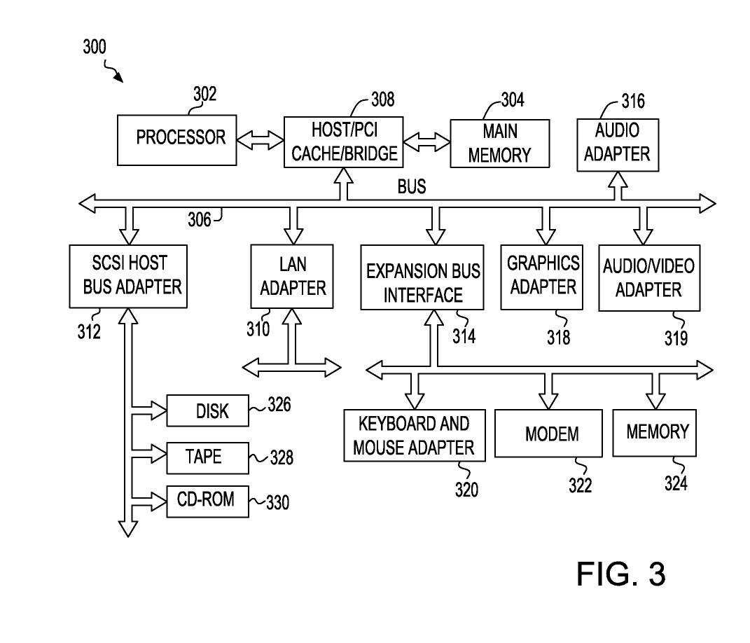

Referring to FIG. 3, there is shown a block diagram of a data processing system. Data processing system 300 is an example of a client computer and employs a peripheral component interconnect (PCI) local bus architecture. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In FIG. 3, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations can support three or four PCI expansion slots or add-in connectors.

An operating system runs on processor 302 and is used to coordinate and provide control of various components within data processing system 300 in FIG. 3. The operating system may be a commercially available operating system, such as Windows® XP, available from Microsoft® Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

The hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data. Data processing system 300 also may be a notebook computer or hand held computer in addition to taking the form of a PDA.

In an embodiment of the invention disclosed herein, an efficiency of distributing traffic (e.g., a message) to application instances can be improved by monitoring a data processing system to obtain each application instance's specific operational information (e.g., a message processing throughput) that identifies operational characteristics of an application instance and using this operational information to select an application instance to process traffic.

For example, assume that,

Application instance 1 takes on average 10 seconds to perform the processing required per message; and

Application instance 2 takes on average 60 seconds to perform the processing required per message.

Now:
At 0 seconds:
   Application instance 1 waits for traffic (message).
   Application instance 2 waits for traffic (message).
At 5 seconds: Traffic (message) arrives.
   Application instance 1 will be busy for the next 5 seconds.

The system has determined that there are two options, to give the traffic to application instance 2 which takes 60 seconds to perform the processing; or wait for application instance 1 which will take 15 seconds ( 5 seconds wait+10 seconds processing).
At 10 seconds:Application instance 1 retrieves the traffic.
At 20 seconds: Application instance 1 completes processing and waits for new traffic.
At 20 seconds: Application instance 1 retrieves new traffic
At 30 seconds: Application instance 1 completes processing new traffic.

In the above example, application instance 1 could have received and processed traffic twice while application instance 2 would still be processing the first traffic.

According to one embodiment of the present invention, a data processing system (e.g., a data processing environment 100 in FIG. 1) includes a plurality of application instances (e.g., Java® Message Service consumers) on one or more computing devices (e.g., servers 104, 108 and 110 in FIG. 1 and a client 112 in FIG. 1). The plurality of the application instance includes a currently available application instance and a currently unavailable application instance. The currently available application instance refers to an application instance that can start to process a message immediately (e.g., an application that is available for a message to be dispatched to). The currently unavailable application instance refers to an application instance that cannot immediately start to process a message, e.g., because the application instance is currently processing another message. Upon receiving a message, the data processing system may assign the message to an application instance to process the message. According to this embodiment, the data processing system assigns the message to an application instance in order to maximize a message processing throughput (i.e., how many messages a data processing system can process in a minute). Thus, the data processing system may assign the message to the currently unavailable application instance in order to increase the message processing throughput of the data processing system.

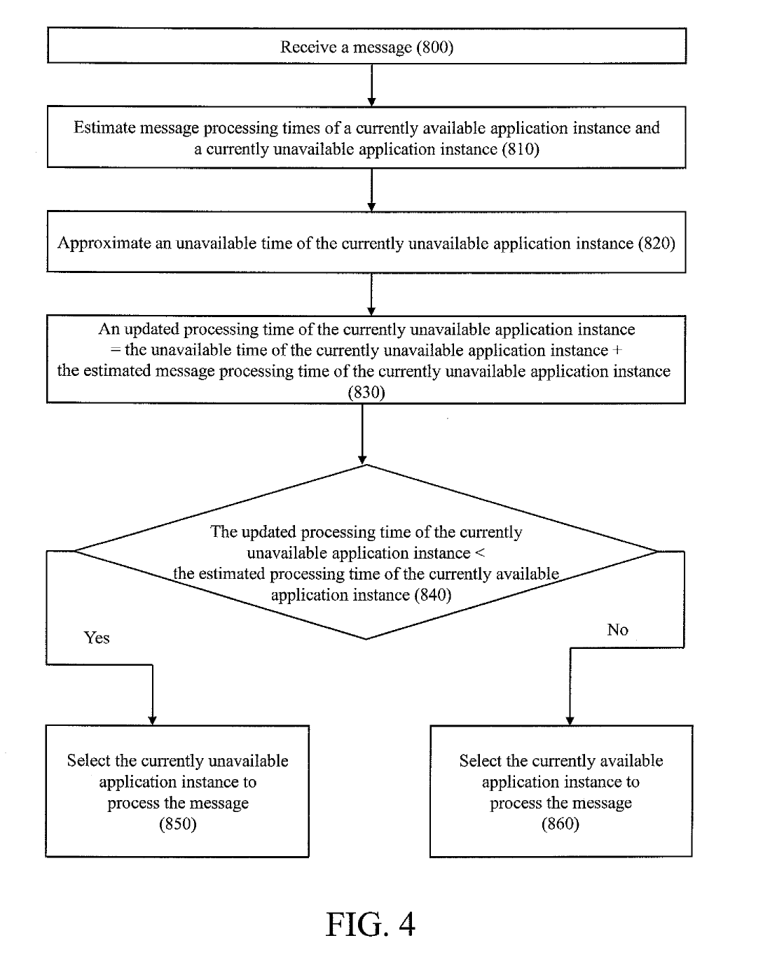

To determine where the data processing system assign a received message to process the message, the data processing system executes method steps described in FIG. 4 according to one embodiment of the present invention. At step 800, the data processing system receives a message, e.g., a network message (i.e., a message exchanged between computers to establish a communication path between them; e.g., http request, open_channel request, ACK). At step 810, the data processing system estimates message processing times (i.e., how long it takes for an application instance to process a message) of the currently available application instance and the currently unavailable application instance, e.g., by using statistics of the application instances. At step 820, the data processing system approximates an unavailable time (i.e., how long it takes for an application instance to complete processing a message which is currently being processed) based on the estimated message processing time of the currently unavailable application instance. For example, if an application instance takes average 5 seconds to process a message, the application instance may complete processing a message within 3 seconds if the application instance started to process the message 2 seconds before.

At step 830, the data processing system adds the approximated unavailable time and the estimated message processing time of the currently unavailable application instance to generate an updated processing time of the currently unavailable application instance. For example, if the approximated unavailable time is 2 seconds and the estimated processing time is 5 seconds, then the updated processing time is 7 seconds (i.e., 2 seconds+5 seconds).

At step 840, the data processing system compares the estimated processing time of the currently available application instance and the updated processing time of the currently unavailable processing time. If the updated processing time of the currently unavailable application instance is less than the estimated processing time of the currently available application instance, at step 850, the data processing time selects the currently unavailable application instance to process the message. Otherwise, at step 860, the data processing system selects the currently available application instance. For example, if the updated processing time of the currently unavailable application instance is 7 seconds and the estimated processing time of the currently available application instance is 60 seconds, the data processing system selects the currently unavailable application instance to process the message.

In a further embodiment of the present invention, the data processing system estimates a message processing time of an application instance by measuring an average message retrieval time. The average message retrieval time refers to an average elapsed time between a retrieval time of a message from a message queue and a retrieval time of a next message from the message queue. Thus, the data processing system measures average message retrieval times of the currently available application instance and the currently unavailable application instance, and designates the estimated average message retrieval times as the estimated message processing times of the application instances. In this embodiment, an application instance may not perform multiple tasks concurrently (e.g., retrieve a message from a queue while processing another message). Thus, the application instance may perform tasks sequentially according to this embodiment.

In a further embodiment of the present invention, the data processing system estimates a message processing time of an application instance by measuring an average message transaction processing time of the application instance. Preferably, a message transaction is associated with work done (e.g. logging a message; inserting a message into a message queue, modifying a message in a message queue and removing a message in a message queue) on a single message.

The average message transaction time is associated with, for example, an average time associated with logging a message of a message transaction. Preferably, a message transaction processing time can be determined by monitoring “syncpoint” (namely, the start point and the end point of a message transaction—wherein typically, a consumer of a message indicates the start point and the end point of a message transaction to a transaction coordinator).Preferably, the data processing system measures average transaction processing times of the currently available application instance and the currently unavailable application instance, and designates the measured average transaction processing times as the estimated message processing times of the application instances.

In a further embodiment of the present invention, the data processing system estimates a message processing time of an application instance by measuring an average message placement time. The average message placement time refers to an average elapsed time between a time of retrieving a message from a message queue and a time of placing another message on a reply queue. The reply queue refers to a queue storing replies from an application instance. Thus, the data processing system measures average message placement times of the currently available application instance and the currently unavailable application instance, and designates the measured average message placement times as the estimated message processing times of the application instances. In this embodiment, an application instance can perform tasks concurrently as well as sequentially. Upon completing processing of a message, an application instance needs to notify a messaging engine (i.e., a device passing messages between data processing systems) by placing the process message on the reply queue.

The following describes exemplary pseudo code that may be executed in one or more computing devices in the data processing system according to one embodiment of the present invention.

| | |
|---|---|
| messageArrive (Message message, Consumers consumers) { | (1) |
| for (currentConsumer in consumers) { | (2) |
| timeForCurrentConsumerToCompleteMessage = | (3) |
| currentConsumer.estimatedTimeToProcessMessage( ) | |
| if (currentConsumer.isCurrentlyWorking( )) { | (4) |
| timeForCurrentConsumerToCompleteMessage += | (5) |
| currentConsumer.estimatedTimeToFinishCurrentMessage( ) | |
| } | |
| if (timeForCurrentConsumerToCompleteMessage < | (6) |
| timeForMostEfficientConsumerToCompleteMessage) { | |
| mostEfficientConsumer = currentConsumer | (7) |
| timeForMostEfficientConsumerToCompleteMessage = | (8) |
| timeForCurrentConsumerToCompleteMessage | |
| } | |
| } | |
| mostEfficientConsumer.sendMessage (message) | (9) |
| } | |

In the above exemplary pseudo code, line (1) defines a method or function to select a consumer (i.e., an application instance) to process a current message (i.e., a message just arrived at the data processing system to be processed). The method receives the current message and a set of consumers as inputs. Line (2) begins a loop to evaluate, for every consumer, whether the consumer is the most efficient consumer to process the current message. Lines (3)-(8), performed in the loop, describe how to evaluate whether a consumer is the most efficient consumer. Line (3) estimates a message processing time of a current consumer (i.e., an application instance currently being evaluated). Line (4) evaluates whether the current consumer is currently unavailable, e.g., because of processing a previous message. If the current consumer is currently unavailable, line (5) estimates an unavailable time of the current consumer (i.e., how long it takes for the current consumer to be available; how long it takes for the current consumer to complete processing of the previous message). Then, line (5) adds the estimated unavailable time and the estimated message processing time to generate an updated processing time (i.e., the updated processing time=the estimated unavailable time+the estimated message processing time).

Line (6) compares the updated processing time of the current consumer and a message processing time of the most efficient consumer so far. If the updated processing time of the current consumer is less than the message processing time of the most efficient consumer so far, line (7) designates the current consumer as the most efficient consumer so far. At line (8), the update processing time of the current consumer becomes the message processing time of the most efficient consumer so far. After evaluating all consumers by executing lines (3)-(8) for every consumer, line (9) selects the most efficient consumer so far to process the current message.

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

The present invention may be implemented as a computer readable medium (e.g., a compact disc, a magnetic disk, a hard disk, an optical disk, solid state drive, digital versatile disc) storing program computer instructions (e.g., C, C++, Java, Assembly languages, .Net, Binary code) executed by a processor (e.g., Intel® Core™, IBM® PowerPC®) for causing a computer to perform method steps of this invention. The present invention may include a method of deploying a computer program product including a program of instructions in a computer readable medium for one or more functions of this invention, wherein, when the program of instructions is executed by at least one processor, the compute program product performs the one or more of functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method, in a data processing system including a plurality of application instances on one or more computing devices, the plurality of application instances including a currently available application instance and a currently unavailable application instance, for assigning a message to an application instance among the plurality application instances including the currently available application instance and the currently unavailable application instance, the method comprising:
estimating message processing times of a currently available application instance and the currently unavailable application instance;
approximating an unavailable time of the currently unavailable application instance based on the estimated message processing time of the currently unavailable application instance;
using the unavailable time of the currently unavailable application instance and the estimated message processing time of the currently unavailable application instance to generate an updated processing time of the currently unavailable application instance;
comparing the estimated processing time of the currently available application instance and the updated processing time of the currently unavailable application instance; and selecting the currently unavailable application instance to process the message if the updated processing time of the currently unavailable application instance is less than the estimated processing time of the currently available application instance.

2. The method of claim 1, further comprising:
otherwise, selecting the currently available application instance.

3. The method of claim 1, wherein the step of estimating comprises:
measuring an average message retrieval time of the currently available application instance, the average message retrieval time representing an average elapsed time between a retrieval time of a message and a retrieval time of a next message; and
measuring an average message retrieval time of the currently unavailable application instance.

4. The method of claim 1, wherein the step of estimating comprises:
measuring an average message transaction processing time of the currently available application instance, the average message transaction processing time including an average time associated with logging a message of a message transaction, the message transaction including logging a message, inserting a message into a message queue, modifying a message in a message queue, removing a message in a message queue; and
measuring an average message transaction processing time of the currently unavailable application instance.

5. The method of claim 1, wherein the step of estimating comprises:
measuring an average message placement time of the currently available application instance, the average message placement time representing an average elapsed time between a time of retrieving a message from a message queue and a time of placing another message on a reply queue, the reply queue storing replies from the currently available application instance; and
measuring an average message placement time of the currently unavailable application instance.

6. The method of claim 1, whereby a message processing throughput of the data processing system increases by selecting the currently unavailable application instance.

7. A computer readable medium storing computer program instructions being executed by a processor for causing a data processing system including a plurality of application instances to perform method steps for assigning a message to an application instance among the plurality application instances including a currently available application instance and a currently unavailable application instance, said method steps comprising:
estimating message processing times of a currently available application instance and the currently unavailable application instance;
approximating an unavailable time of the currently unavailable application instance based on the estimated message processing time of the currently unavailable application instance;
using the unavailable time of the currently unavailable application instance and the estimated message processing time of the currently unavailable application instance to generate an updated processing time of the currently unavailable application instance;
comparing the estimated processing time of the currently available application instance and the updated processing time of the currently unavailable application instance; and
selecting the currently unavailable application instance to process the message if the updated processing time of the currently unavailable application instance is less than the estimated processing time of the currently available application instance.

8. The computer readable medium of claim 7, further comprising:
otherwise, selecting the currently available application instance.

9. A data processing system including a plurality of application instances on one or more computing devices, the plurality of application instances including a currently available application instance and a currently unavailable application instance, for assigning a message to an application instance among the plurality application instances including the currently available application instance and the currently unavailable application instance, comprising:
means for estimating message processing times of a currently available application instance and the currently unavailable application instance;
approximating an unavailable time of the currently unavailable application instance based on the estimated message processing time of the currently unavailable application instance;
means for using the unavailable time of the currently unavailable application instance and the estimated message processing time of the currently unavailable application instance to generate an updated processing time of the currently unavailable application instance;
means for comparing the estimated processing time of the currently available application instance and the updated processing time of the currently unavailable application instance; and
means for selecting the currently unavailable application instance to process the message if the updated processing time of the currently unavailable application instance is less than the estimated processing time of the currently available application instance.

10. The data processing system of claim 9, further comprising:
means for selecting the currently available application instance, otherwise.

11. The data processing system of claim 9, wherein the means for estimating comprises:
means for measuring an average message retrieval time of the currently available application instance, the average message retrieval time representing an average elapsed time between a retrieval time of a message and a retrieval time of a next message; and
measuring an average message retrieval time of the currently unavailable application instance.

12. The data processing system of claim 9, wherein the means for estimating comprises:
means for measuring an average message transaction processing time of the currently available application instance, the average message transaction processing time including an average time associated with logging a message of a message transaction, the message transaction including logging a message, inserting a message into a message queue, modifying a message in a message queue, removing a message in a message queue; and
means for measuring an average transaction processing time of the currently unavailable application instance.

13. The data processing system of claim 9, wherein the means for estimating comprises:
means for measuring an average message placement time of the currently available application instance, the average message placement time representing an average elapsed time between a time of retrieving a message from a message queue and a time of placing another message on a reply queue, the reply queue storing replies from the currently available application instance; and
means for measuring an average message placement time of the currently unavailable application instance.

14. The data processing system of claim 9, whereby a message processing throughput of the data processing system increases by selecting the currently unavailable application instance.

15. A method of deploying a computer program product including programs of instructions in a computer readable medium for assigning a message to an application instance in a data processing system including a plurality of application instances on one or more computing devices having at least one processor, the plurality of application instance including a currently available application instance and a currently unavailable application instance, wherein, when the programs of instructions are executed by the at least one processor, the computer program product performs the steps of claim 1.
